(19) United States
(12) Patent Application Publication
(10) Pub. No.: US 2015/0000183 A1
(43) Pub. Date: Jan. 1, 2015

(54) INSECT-DISCOURAGING KIT

(71) Applicant: Michael A. Sapara, JR., Oregon, OH (US)

(72) Inventor: Michael A. Sapara, JR., Oregon, OH (US)

(73) Assignee: BLACKHAWK LLC, Oregon, OH (US)

(21) Appl. No.: 13/887,892

(22) Filed: May 6, 2013

Related U.S. Application Data
(60) Provisional application No. 61/643,224, filed on May 4, 2012.

(51) Int. Cl. A01M 1/20

(52) U.S. Cl. CPC A01M 1/20
USPC 43/131

(57) ABSTRACT

An insect-discouraging kit (200) comprising a device (300) installable in a drain outlet, a device (400) installable in a sink basin, and a solution (400) for cleaning floors around a sink station. The device (300) and the device (400) each include a dissolvable body incorporating the insect-discouraging material which dispenses over a period of time without human participation.

### RELATED APPLICATIONS

This application claims priority under 35 USC §119(e) to US Provisional Patent Application No. 61/643,224 filed on May 4, 2012. This application is also related to International Patent Application No. PCT/IS2-11/048705 filed on Aug. 22, 2011 and U.S. Provisional Patent Application No. 61/375,399 filed on Aug. 20, 2010 from which priority is claimed in the PCT case. The entire disclosures of these earlier applications are hereby incorporated by reference. To the extent that inconsistencies exist between the earlier applications and the present application, the present disclosure governs for the purposes of resolving any indefiniteness of inconsistency issues.

### BACKGROUND

A commercial sink system, such as is used in a restaurant setting, have a propensity to create a rich feeding and breeding ground for insects such as fruit flies. This problem has traditionally been addressed by kitchen personnel (e.g., a dishwasher or other behind-the-scenes worker) being assigned the daily task of pouring a chemical gel in the floor drain. When this protocol is ineffective (or more commonly, not followed) insects inevitably invade the premise and make an enjoyable dining experience impossible. An establishment often has no choice but to shut its doors and set off a “bug bomb” producing a pesticide fog that permeates everywhere. This results in lost revenue during the restaurant's downtime and also an expensive post-bomb cleanup operation.

### SUMMARY

An insect-discouraging kit is provided which includes devices which can automatically (i.e., without continuous human interaction) dispense an insect-discouraging material over a period of time in a sink system. This automatic insect-discouraging dispensement can keep a restaurant insect-free and open for business, even with unreliable kitchen personnel. And the devices can be constructed for installation in existing commercial sink systems, whereby they requires little capital investment.

### DRAWINGS

FIG. 1 shows a sink system 100.

FIGS. 2-4 show an insect-discouraging kit 200, an insect-discouraging device 300, and an insect-discouraging device 400.

### DESCRIPTION

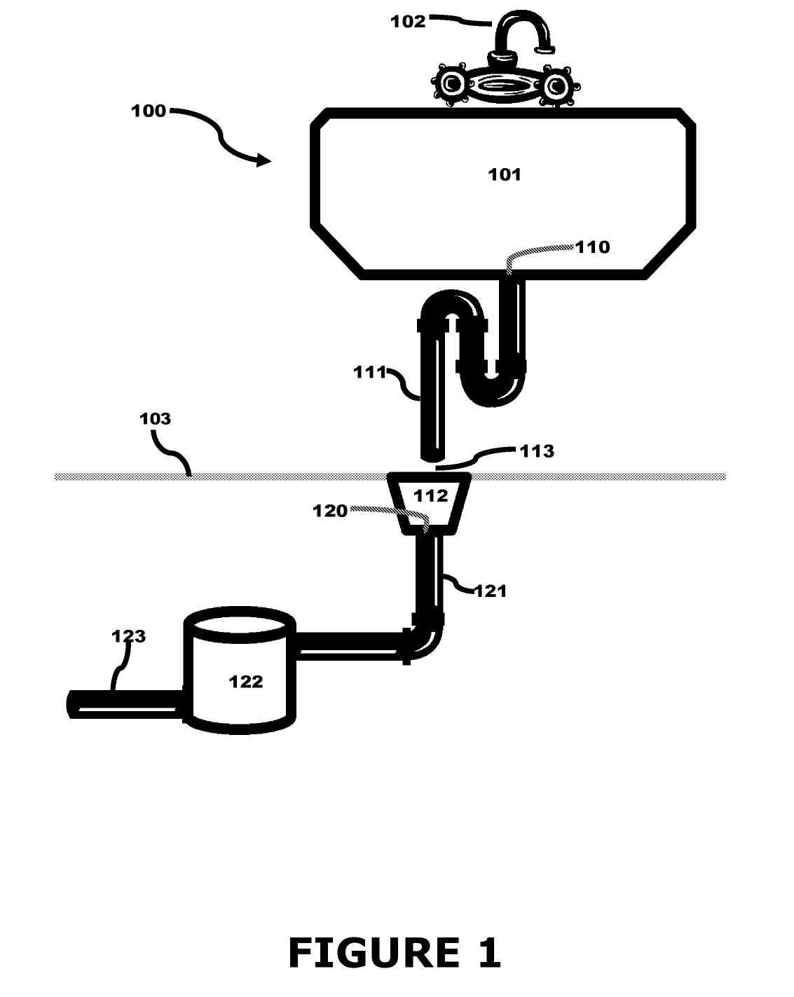

Referring now to the drawings, and initially to FIG. 1, a typical sink system 100 is shown. The system 100 comprises a basin 101 with a faucet 102 positioned to supply water thereto. The sink basin 101 can be, for example, located in a food-preparation station (whereat fruits, vegetables, and other food are rinsed), a dish-cleaning station (whereat edible remains are removed from plates, pots, pans, and other containers), a drink-service station (whereat beverage residue is poured from glasses), a washing station (whereat hands are cleansed), or any other station. The kitchen or other area containing the basin 101 will typically include a floor 103.

The basin 101 can have a bottom drain outlet 110 and a pipe 111 extending downward therefrom. A crock 112 is situated below the exit end of the pipe 111 so as to provide an air gap 113 therebetween. The crock 112 has a drain outlet 120 and another pipe 121 can extend therefrom to a grease-trap container 122. A further pipe 123 can connect the container 122 to a sewer line.

Water drained from the basin 101 flows through the basin drain outlet 110 into the pipe 111, through the pipe 111 into the crock 112, through the crock drain outlet 114 into the pipe 115, through the pipe 115 into the grease-trap container 116.

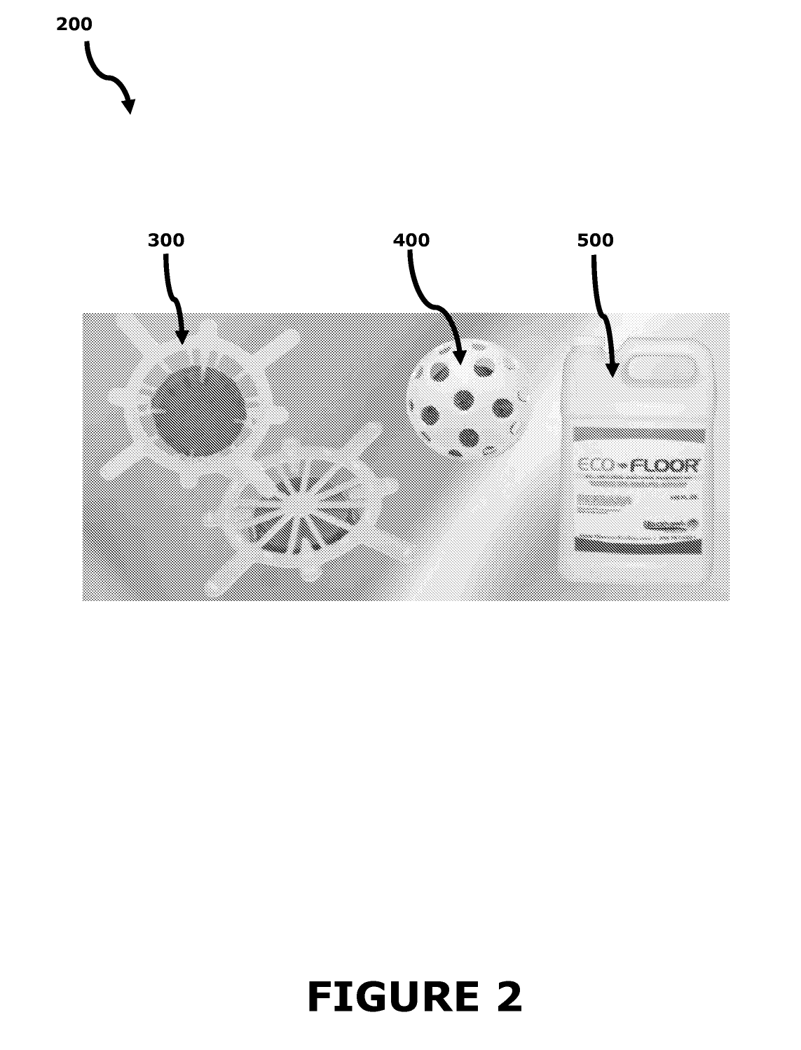

Referring to FIG. 2, an insect-discouraging kit 200 comprises an insect-discouraging device 300 for placement in the drain outlet 110, an insect-discouraging device 400 for placement in a sink basin 101 (e.g., one that does not have a drain outlet suitable for the device 300), and a liquid solution 500 for the floor 103. The device 300, the device 400, and the solution 500 comprise insect-discouraging material which may comprise formulated chemicals, biological pesticides, viral agents, and/or micro-organisms. Such insect-discouragers are usually available in a variety of forms (e.g., powder, granules, liquid, etc.) whereby a format can be chosen that is compatible with the selected device design and the intended venue.

The insect-discouraging material can be included in a composition containing other ingredients such as diluents, adjuvants, dyes, alcohols, acetone, ketones, oils, surfactants, water, emulsifiers, film-forming agents, compatibility agents, wetting agents, salt, natural or synthetic polymers, hydrocolloids, buoyancy modifiers, ultraviolet absorbers, photo-protecting agents, suspending agents, elastomers, penetrants, deflocculating agents, dispersing agents, stabilizing agents, antifoaming agents, sticking agents, solvents, co-solvents, catalysts, and/or synergists.

While the insect-discouraging material may comprise pesticides, this need not be the case. In fact, the device can be characterized by the absence of pesticides in the insect-discouraging material.

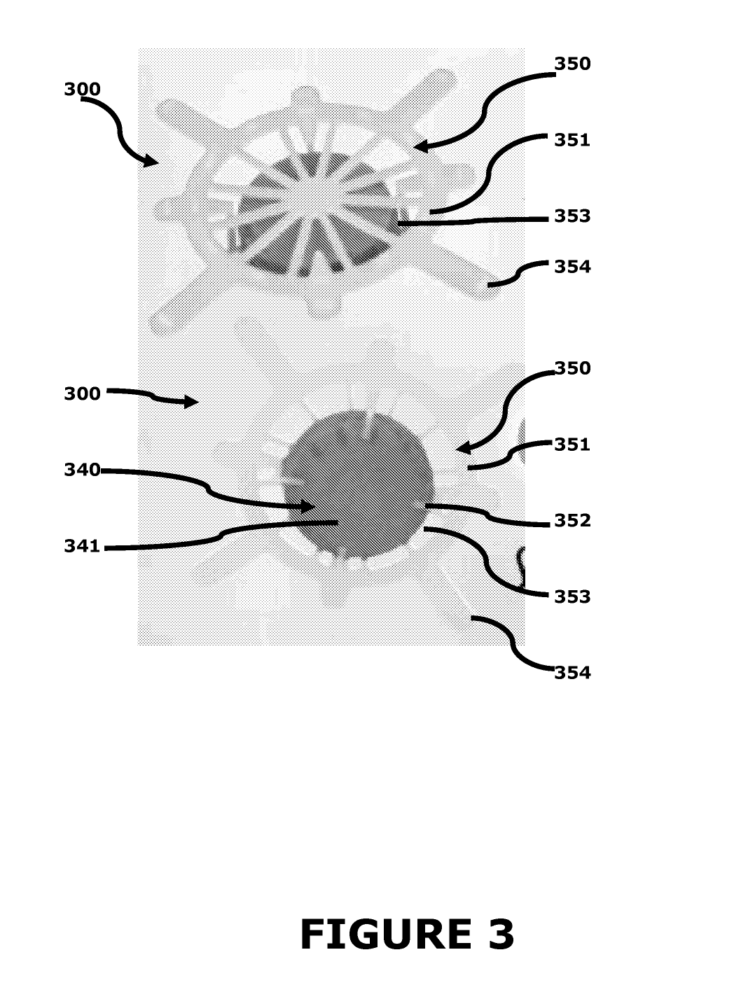

Referring to FIG. 3, the insect-discouraging device 300 is adapted for installation in the basin drain outlet 110 or the crock drain outlet 120. The device 300 includes an insect-discouraging dispenser 340 which dispenses an insect-discouraging material over a period of time without human participation. More particularly, as water drains through the outlet 110/120 and thus through the device 300, the insect-discouraging material is dispensed.

The dispenser 340 can comprise a dissolvable body 341 which incorporates the insect-discouraging material. In the illustrated embodiment, the body 341 has a disk shape.

The insect-discouraging device 300 can further comprise a platform 350 which mounts the dispenser 340 in the drain outlet 110/120. This mounting platform 350 can have a circular shelf-like body 351 shaped and sized to cover the drain 110/120. Hooks or clips 352 can extend downward from platform shelf 351 in a circular pattern so as to capture the body 341. Spokes 353 can extend radially outward from the shelf 351 to elevate the platform 350 above the drain pipe.

The circular shelf 351 can have a screen-like construction or otherwise be provided with straining passageways 354. The platform 350 can be reusable, but it preferably disposable upon dissolution of the body 341. The platform 350 can be made of a molded plastic and/or formed in one piece.

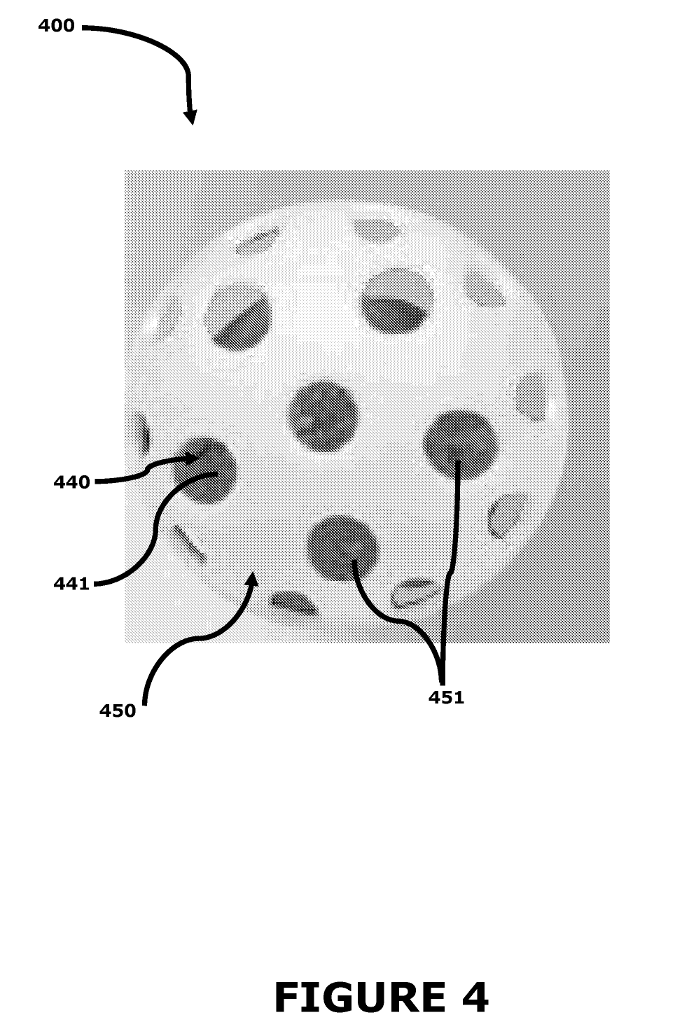

Referring to FIG. 4, the insect-discouraging device 400 is adapted for installation in a sink basin 101 or a crock 112. The device 400 includes an insect-discouraging dispenser 440 comprising a dissolvable body 441 which incorporates the insect-discouraging material. The body 441 can have, for example, a spherical shape.

The insect-discouraging device 400 further comprises a cage 450 in which the dispenser 440 and/or the dissolvable body 441 is contained. The cage 450 can have a hollow spherical shape with holes 451 extending therethrough. The cage 450 can have a two-part construction which is assembled around the body 441. Alternatively, the cage 450 can have a one-part construction molded around or injected with the dissolvable body 441.

One may now appreciate that the device 30 passively and automatically provides insect-discouraging protection for the sink system 10. Although the sink system 10, the device 30, the mounting part 40, and/or the dispenser 50 have been shown and described with respect to a certain embodiment or embodiments, it is obvious that equivalent alterations and modifications will occur to others skilled in the art upon the reading and understanding of this specification and the annexed drawings.

1. An insect-discouraging kit comprising a first insect-discouraging device and a second insect-discouraging device;
wherein the first insect-discouraging device comprises:
a dispenser which dispenses insect-discouraging material over a period of time without human participation, the dispenser including a dissolvable body incorporating the insect-discouraging material; and
a platform which mounts the dispenser in the sink system, the platform comprising a shelf-like body and a hooks or clips which extend downward therefrom to capture the dissolvable body;
wherein the second inset-discouraging device comprises:
a dispenser which dispenses insect-discouraging material over a period of time without human participation, the dispenser including a dissolvable body incorporating the insect-discouraging material; and
a cage in which the dissolvable body is contained.

2. An insect-discouraging kit as set forth in claim 1, further comprising a liquid solution for application to a floor.

3. An insect-discouraging kit as set forth in claim 1, wherein the insect-discouraging material comprises a pesticide.

4. An insect-discouraging kit as set forth in claim 1, wherein the insect-discouraging material is characterized by the absence of a pesticide.

5. An insect-discouraging kit as set forth in claim 1, wherein the insect-discouraging material is formulated to provide an effective dosage for a period of time of at least one week.

6. An insect-discouraging kit as set forth in claim 1, wherein the insect-discouraging material is in powder form.

7. An insect-discouraging kit as set forth in claim 1, wherein the insect-discouraging material is in granule form.

8. An insect-discouraging kit as set forth in claim 1, wherein the insect-discouraging material is in liquid form.

9. An insect-discouraging kit as set forth in claim 1, wherein the body of the first insect-discouraging device has a disk shape, and wherein its platform has a circular shelf-like shape.

10. An insect-discouraging kit as set forth in claim 9, wherein the platform is made of molded plastic and is formed in one piece.

11. An insect-discouraging kit as set forth in claim 10, wherein the platform is reusable.

12. An insect-discouraging kit as set forth in claim 10, wherein the platform is intended for disposal upon dissolution of the dispensing body.

13. An insect-discouraging kit as set forth in claim 1, wherein the body of the second insect-discouraging device has a spherical shape and wherein its cage has a hollow spherical shape.

14. An insect-discouraging kit as set forth in claim 13, wherein the cage is made of plastic.

15. An insect-discouraging kit as set forth in claim 14, wherein the cage has a two-part construction.

16-20. (canceled)

21. An insect-discouraging device comprising:
a dispenser which dispenses insect-discouraging material over a period of time without human participation, the dispenser including a dissolvable body incorporating the insect-discouraging material; and
a cage in which the dissolvable body is contained, the cage having a spherical shape.

22. An insect-discouraging device as set forth in claim 21, wherein the cage is made of plastic.

23. An insect-discouraging device as set forth in claim 21, wherein the cage has a two-part construction.

24. An insect-discouraging device as set forth in claim 21, wherein the insect-discouraging material is characterized by the absence of a pesticide.

25. An insect-discouraging device as set forth in claim 21, wherein the insect-discouraging material is formulated to provide an effective dosage for a period of time of at least one week.
